(19) United States
(12) Patent Application Publication
(10) Pub. No.: US 2026/0071887 A1
(43) Pub. Date: Mar. 12, 2026

(54) VECTORIZED HIGH DEFINITION (HD) MAP PREDICTION USING SEMANTIC MAPS

(71) Applicant: QUALCOMM Incorporated, San Diego, CA (US)

(72) Inventors: Behnaz Rezaei, San Diego, CA (US); Mohammadreza Malek-Mohammadi, Solna (SE); Saeed Dabbaghchian, Bromma (SE); Senthil Kumar Yogamani, San Diego, CA (US)

(21) Appl. No.: 18/826,509

(22) Filed: Sep. 6, 2024

(51) Int. Cl. G01C 21/00

(52) U.S. Cl. CPC G01C 21/3815; G01C 21/3833; G01C 21/3867; G01C 21/3878

(57) ABSTRACT

A method for generating predictions for vectorized High Definition (HD) map elements includes obtaining sensor data generated by sensors of a vehicle; extracting feature maps from the sensor data; identifying anchor regions based on the feature maps, wherein the anchor regions represent potential locations for vectorized HD map elements, and wherein the vectorized HD map represents an environment surrounding the vehicle; generating initial object queries in the anchor regions, wherein the initial object queries are associated with a specific vectorized HD map element; refining, by a transformer decoder, the initial object queries based on the feature maps to generate refined object queries; and generating predictions for the vectorized HD map elements based on the refined object queries.

### TECHNICAL FIELD

This disclosure relates to machine learning in computing systems.

### BACKGROUND

Unlike traditional maps, High Definition (HD) maps are packed with rich details beyond just where the roads are located. HD maps may include elements such as, but not limited to, lane markings, boundaries of roads and lanes, pedestrian crossings, and even information about dividers and signs. This extra detail may be important for Advanced Driver Assistance Systems (ADAS) to understand their surroundings precisely.

An ADAS is designed to support the driver, not replace them. An ADAS may use sensors and software to warn drivers of potential hazards and can even take corrective actions like automatic emergency braking.

### SUMMARY

In general, this disclosure describes techniques for improving the convergence of a transformer model used for processing map data. In some instances, the disclosed system may provide the transformer model with better initial information and may limit the attention scope of the transformer model. Instead of starting with a generic query, the disclosed machine learning system may use a “map object query” based on specific “anchor regions. ” These regions may be identified beforehand using a separate segmentation unit within the machine learning system. The transformer unit may receive a more focused starting point based on more relevant parts of the map.

In one example, a method for generating predictions for vectorized High Definition (HD) map elements includes obtaining sensor data generated by one or more sensors of a vehicle; extracting one or more feature maps from the sensor data; identifying one or more anchor regions based on the one or more feature maps, wherein the one or more anchor regions represent potential locations for one or more vectorized HD map elements, and wherein the vectorized HD map represents an environment surrounding the vehicle; generating one or more initial object queries in the one or more anchor regions, wherein the one or more initial object queries are associated with a specific vectorized HD map element; refining, by a transformer decoder, the one or more initial object queries based on the one or more feature maps to generate one or more refined object queries; and generating one or more predictions for the one or more vectorized HD map elements based on the one or more refined object queries.

In another example, an apparatus for generating predictions for vectorized High Definition (HD) map elements includes a memory for storing sensor data; and processing circuitry in communication with the memory. The processing circuitry is configured to obtain the sensor data generated by one or more sensors of a vehicle. The processing circuitry is also configured to extract one or more feature maps from the sensor data and identify one or more anchor regions based on the one or more feature maps, wherein the one or more anchor regions represent potential locations for one or more vectorized HD map elements, and wherein the vectorized HD map represents an environment surrounding the vehicle. The processing circuitry is further configured to generate one or more initial object queries in the one or more anchor regions, wherein the one or more initial object queries are associated with a specific vectorized HD map element and refine, by a transformer decoder, the one or more initial object queries based on the one or more feature maps to generate one or more refined object queries. Finally, the processing circuitry is configured to generate one or more predictions for the one or more vectorized HD map elements based on the one or more refined object queries.

In yet another example, non-transitory computer-readable storage media having instructions encoded thereon, the instructions configured to cause processing circuitry to: obtain sensor data generated by one or more sensors of a vehicle and extract one or more feature maps from the sensor data. Additionally, the instructions are configured to cause the processing circuitry to identify one or more anchor regions based on the one or more feature maps, wherein the one or more anchor regions represent potential locations for one or more vectorized HD map elements, and wherein the vectorized HD map represents an environment surrounding the vehicle and to generate one or more initial object queries in the one or more anchor regions, wherein the one or more initial object queries are associated with a specific vectorized HD map element. Finally, the instructions are configured to cause the processing circuitry to refine, by a transformer decoder, the one or more initial object queries based on the one or more feature maps to generate one or more refined object queries and to generate one or more predictions for the one or more vectorized HD map elements based on the one or more refined object queries.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example vehicle, in accordance with the techniques of this disclosure.

FIG. 2 is a block diagram illustrating an example computing system that may perform the techniques of this disclosure.

FIG. 3 illustrates difficulties to optimize prediction slots of object queries.

FIG. 4 is a block diagram illustrating an architecture of a system configured to perform vectorized HD map prediction using semantic maps in accordance with the techniques of this disclosure.

FIG. 5 illustrates a probability map in accordance with the techniques of this disclosure.

FIG. 6 is a flowchart illustrating an example method for generating predictions for vectorized HD map elements in accordance with the techniques of this disclosure.

### DETAILED DESCRIPTION

With detailed information provided by HD maps, an ADAS may use HD maps to plan their movements. An ADAS may analyze the map data and determine safe and efficient way to navigate, considering elements like lane changes, turns, and avoiding obstacles like pedestrians. In some examples, HD maps store data using polylines and polygons. Polylines, which are basically connected lines, may represent lane boundaries. Polygons, which are areas enclosed by multiple lines, may depict pedestrian crossings and other defined zones. This vectorized approach may allow for compact storage and more precise calculations during motion planning. In essence, HD maps may act like a digital super-guide for an ADAS, providing the ADAS with a more comprehensive understanding of the road and its features. Traditionally, vectorized map prediction may rely on convolutional neural networks (CNNs) to extract features from raw sensor data (like LiDAR and/or camera) and then predict the corresponding map elements (polylines/polygons). While CNNs are powerful for feature extraction, CNNs may struggle with capturing long-range dependencies in the data. Long-range dependencies in data may be important for tasks like predicting road/lane boundaries, which often stretch across the entire image.

The encoder-decoder structure of transformers offers unique benefits. The encoder may take the raw sensor data (like a camera and LiDAR scan) and may process the sensor data, capturing local features and their relationships. The decoder may leverage this encoded information to predict the vectorized map elements (e.g., polylines/polygons).

At the core of many ADAS features lies one or more Machine Learning (ML) models, particularly models that may analyze sensor data. For example, an ADAS may use an ML model to analyze a sequence of images from a forward-facing camera. Based on what the model detects in the images, the model may alert the driver of a potential obstacle or initiate automatic braking, among other actions.

This disclosure describes techniques that utilize transformer encoder-decoder structures for vectorized map prediction, alongside their established roles in object detection and segmentation. Capturing relationships between distant points on a map may be important for some use cases. For example, a lane marking far ahead may be relevant to understand the upcoming path. Traditional models often struggle with these long-range dependencies. The encoder-decoder architecture of transformers separates feature extraction (encoder) from prediction (decoder). The encoder may analyze the entire map at once, capturing these long-range dependencies effectively. A self-attention mechanism may allow a ML model to directly attend to any part of the map, regardless of distance. The self-attention mechanism may assess the relevance of each point to the prediction task, considering the overall context. Roads and lane markings often stretch across the map, making them good examples of where long-range context matters. Transformers may excel at capturing the relationships between distant points, leading to more accurate predictions for these elongated objects.

Primary elements are the fundamental building blocks of the vectorized map. The primary elements may represent the actual road features the ML model may be configured to detect, such as, but not limited to: lane boundaries, road edges, pedestrian crossings, traffic signs, and the like. Primary elements may be defined by a series of points called vertices. These points may be considered to be building blocks that connect to form the complete shape of the element. For example, assume an element is a lane boundary. In the vectorized map, the lane boundary may be represented by an array containing a series of vertices. It should be noted that the way these vertices are defined may ensure a specific relationship with the actual road element on the ground.

While transformers may be used in map prediction, their core strengths are similar to their applications in object detection and segmentation. In general, in object detection, transformers may analyze the entire image to understand how objects interact spatially. Similarly, for segmentation, transformers may relate pixels across an image to define object boundaries. This ability to grasp complex spatial relationships translates well to map prediction where understanding connections between distant map elements may be important.

Some advanced ML systems may treat map construction as an object detection problem. In other words, such ML systems may identify and localize elements on a map similar to how object detection identifies objects in an image. The disclosed ML system may use an encoder-decoder structure. In an example, an encoder may be a “bird's-eye view” (BEV) encoder. The BEV encoder may take data from multiple cameras or sensors and may combine the information into a BEV representation.

The disclosed system may use a decoder that may be configured to identify and decoding individual map elements (e.g., roads, lanes, buildings etc.) from the combined data. The decoder may use a set of pre-defined queries, similar to how object detection uses bounding boxes. In this case, each query may correspond to a specific map element. In the techniques described herein, the decoder may assign one “object query” to each map element the decoder is configured to identify. This query may essentially indicate to the decoder what to look for in the encoded data. By matching the object queries with the data, the decoder may determine the location and characteristics of each map element.

Additionally, by attending to relevant parts of the feature map across the entire image, the object query may be refined to more accurately locate the center of the desired object, even for elongated shapes like lane boundaries.

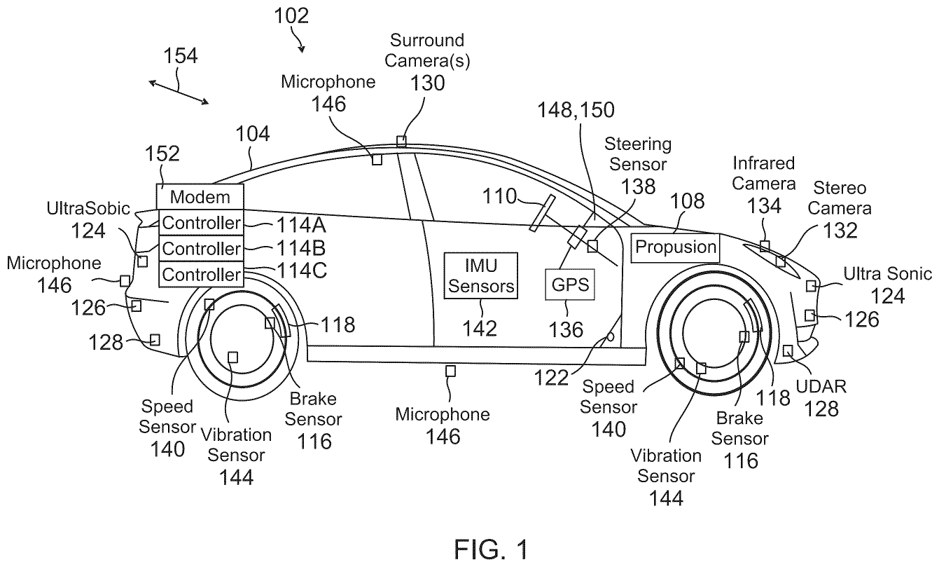

FIG. 1 shows an example vehicle 102. Vehicle 102 in the example shown may comprise a passenger vehicle such as a car or truck that can accommodate a human driver and/or human passengers. In an aspect, vehicle 102 may comprise an autonomous vehicle, semi-autonomous vehicle and/or an ADAS system. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be essentially one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In an aspect, an actuation controller may be obtained with dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, Global Positioning System (“GPS”) data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more RADAR sensors 126, one or more LiDAR sensors 128, one or more surround cameras 130 (typically such cameras are located at various places on vehicle body 104 to image areas all around the vehicle body), one or more stereo cameras 132 (in an aspect, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller has identified the presence of a stop sign, caution sign, or changing traffic light and is taking appropriate action, giving the vehicle occupants peace of mind that the controller 114 is functioning as intended.

In an aspect, instrument cluster 148 may include a separate controller/processor configured to perform deep learning and artificial intelligence functionality.

In some examples, vehicle 102 may collect data that is preferably used to help train and refine the neural networks used for autonomous driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

Compared to sonar and RADAR sensors 126, cameras 130-134 may generate a richer set of features at a fraction of the cost. Thus, vehicle 102 may include a plurality of cameras 130-134, capturing images around the entire periphery of the vehicle 102. Camera type and lens selection depends on the nature and type of function. The vehicle 102 may have a mix of camera types and lenses to provide complete coverage around the vehicle 102; in general, narrow lenses do not have a wide field of view but can see farther. All camera locations on the vehicle 102 may support interfaces such as Gigabit Multimedia Serial link (GMSL) and Gigabit Ethernet.

In an aspect, a controller 114 may obtain sensor data generated by one or more sensors 128-134 of the vehicle 102. Next, controller 114 may extract one or more feature maps from the sensor data. In addition, controller 114 may identify one or more anchor regions based on the one or more feature maps. The one or more anchor regions represent potential locations for one or more vectorized HD map elements. The vectorized HD map represents an environment surrounding the vehicle. Furthermore, controller 114 may generate one or more initial object queries in the one or more anchor regions, wherein the one or more initial object queries are associated with a specific vectorized HD map element. The one or more object queries are associated with a specific vectorized HD map element. Next, controller 114 may employ a transformer decoder to refine the one or more initial object queries based on the one or more feature maps and to generate one or more refined object queries. Finally, controller 114 may generate one or more predictions for the one or more vectorized HD map elements based on the one or more refined queries.

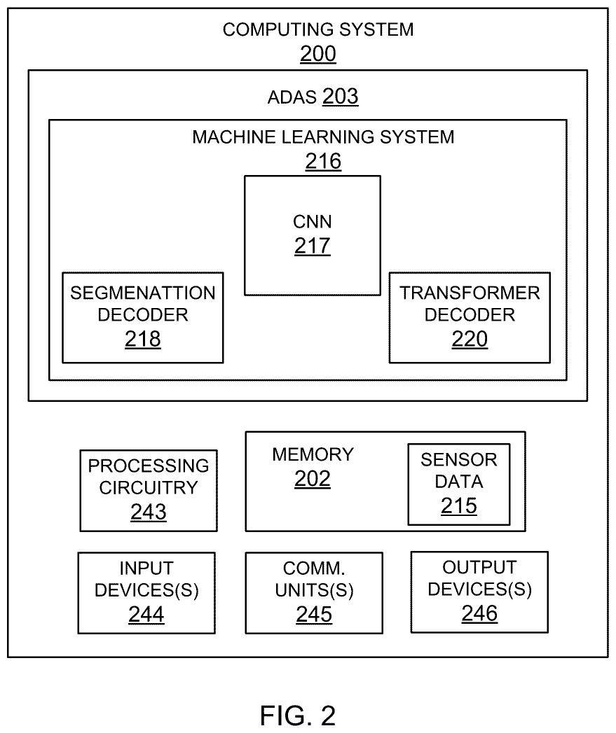

FIG. 2 is a block diagram illustrating an example computing system that may perform the techniques of this disclosure. As shown, computing system 200 comprises processing circuitry 243 and memory 202 for executing ML system 216 of ADAS 203, including CNN 217, segmentation decoder 218 and transformer decoder 220 which may represent an example instance of any controller 114 described in this disclosure, such as controller 114 of FIG. 1.

Computing system 200 may be implemented as any suitable external computing system accessible by controller 114, such as one or more server computers, workstations, laptops, mobile devices, mainframes, embedded computing systems, cloud computing systems, High-Performance Computing (HPC) systems (i.e., supercomputing systems) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. In an aspect, computing system 200 is disposed in vehicle 102.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random-access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable read only memories (EPROM) or electrically erasable and programmable (EEPROM) read only memories.

Memory 202 may store program instructions and/or data associated with one or more of the modules described in accordance with one or more aspects of this disclosure. For example, memory 202 may store multi-modal sensor data 215 received from one or more sensors 128-134 of the vehicle 102.

Processing circuitry 243 and memory 202 may provide an operating environment or platform for one or more modules or units (e.g., ML system 216, including CNN 217, segmentation decoder 218 and transformer decoder 220, etc.), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute ML system 216, including CNN 217, segmentation decoder 218 and transformer decoder 220, using virtualization modules, such as a virtual machine or container executing on underlying hardware. One or more of such modules may execute as one or more services of an operating system or computing platform. Aspects of ML system 216, including CNN 217, segmentation decoder 218 and transformer decoder 220, may execute as one or more executable programs at an application layer of a computing platform.

One or more input device(s) 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output device(s) 246 may generate, transmit, or process output. Examples of output are tactile, audio, visual, and/or video output. Output devices 246 may include a display, sound card, video graphics adapter card, speaker, presence-sensitive screen, one or more universal serial bus (USB) interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, 5G and Wi-Fi® radios found in mobile devices as well as Universal Serial Bus (USB) controllers and the like.

In the example of FIG. 2, ADAS 203 may receive information from various sensors about the surroundings of the vehicle 102. These sensors can include cameras 130-134, radar sensors 126, LiDAR sensors 128, as described herein. ADAS 203 may receive input data. Transformer decoder 220 may generate output data. The input data and output data may contain various types of information. For example, the input data may include, but is not limited to, multi-modal camera/LiDAR data. The output data may include one or more refined queries, generated map classes, map element vertices and so on. The output data may be used by a classification and/or a regression unit.

As noted above, current transformer based HD map prediction system architectures may utilize a camera branch and a LiDAR branch. The LiDAR branch may use a LiDAR point cloud.

A point cloud encoder may pre-process the raw point cloud data. The point cloud encoder may aim to extract meaningful features from the point cloud that can be used to identify map elements. In one example, a point cloud encoder may be a PointNet-based encoder. The PointNet-based encoders may directly operate on the point cloud data, using techniques like multi-layer perceptrons (MLPs) to learn feature representations for each point. In another example, a point cloud encoder may be a voxel-based encoder. The voxel-based encoder may first convert the point cloud into a 3D grid structure called a voxel grid. Each voxel may represent a small region in space. Then, the voxel-based encoder may use 3D convolutions to extract features for each voxel.

The LiDAR branch may also include a LiDAR backbone. The LiDAR backbone may be is a convolutional neural network (CNN) that further processes the encoded point cloud features. The LiDAR backbone may be responsible for extracting higher-level and more abstract features that are relevant for map element detection. The specific architecture of the backbone may vary depending on the ML model, but the backbone may involve multiple convolutional layers with pooling operations. A so-called LiDAR neck stage may aim to aggregate and refine the features extracted by the backbone. In one example, LiDAR neck stage may use an FPN. Similar to the camera branch, the FPN may be used to create feature maps at different scales. FPNs may allow the current transformer based HD map prediction system to capture both fine-grained details (e.g., curbs) and larger structures (e.g., buildings). In another example, the LiDAR neck may use channel attention units.

In one scenario, the channel attention units may focus the attention of the ML model on informative channels within the feature maps, leading to more efficient feature extraction. The current transformer based HD map prediction system may use BEV feature pooling step to transform the processed LiDAR features from a 3D space into a BEV representation. In one example, each point in the point cloud may be “projected” onto the BEV feature map based on its horizontal and vertical location. The corresponding feature from the LiDAR backbone may then be added to the appropriate location in the BEV feature map. In another example, similar to voxel-based encoders, the LiDAR features may be partitioned into a voxel grid in the BEV space. The voxel partitioning may allow for efficient pooling and aggregation of features within each voxel. The final output of the LiDAR branch may be a BEV feature map containing rich information about the surrounding environment extracted from the LiDAR data.

In current transformer-based local HD map prediction systems, the camera BEV features and LiDAR BEV features may not be directly fed into the decoder. There may be an additional processing step involving a BEV encoder. As explained earlier, the camera branch and LiDAR branch may both produce BEV feature maps representing the surrounding environment from their respective sensor modalities (camera images and LiDAR point cloud). The BEV encoder may be a CNN that takes both the camera BEV features and the LiDAR BEV features as input. The purpose of the BEV encoder may be to further process and potentially fuse the information from these two sources. The BEV encoder may combine the complementary strengths of camera and LiDAR data.

For example, cameras may excel at capturing visual details like lane markings, while LiDAR may excel at capturing 3D shapes and object heights. The BEV encoder may learn to combine these features to create a richer and more informative representation. The BEV encoder may further refine the BEV features from each sensor. Feature refinement may involve approaches like dimensionality reduction or noise reduction to improve the quality of the data for the decoder.

The output of the BEV encoder, which may be a single, fused BEV feature map, may then be fed into the transformer decoder along with the object queries. The transformer decoder component may use the fused BEV features and the object queries to predict map elements. The transformer decoder may analyze the combined information from LiDAR and cameras, understanding the relationships between different parts of the scene. As noted above, object queries may be pre-defined queries, each corresponding to a specific map element type (e.g., road, lane, building). The transformer decoder may use classification heads within its architecture to predict the class label for each object query. Classification heads may determine the type of map element the query is associated with. Additionally, the transformer decoder may employ a regression head to predict the bounding box or other geometric parameters that define the location and extent of the detected map element. The final output of the transformer-based local HD map prediction systems may be a set of predictions for various map elements, including their class labels (e.g., road, lane marking) and their corresponding geometric descriptions (e.g., bounding boxes, polylines).

In an aspect, the head of the transformer decoder may have a plurality of layers, each layer of the transformer head (denoted by L layers, l∈{0, . . . L-1}) processes a set of object queries and refines them. The input to the transformer decoder may be a set containing M queries {qₗ₁, . . . , q_{lM}} at layer l. Each query may be a vector with dimensionality C, representing the current understanding of a potential map element. The transformer layer may perform a series of computations on these queries. In one example, self-attention mechanism may allow each query to “attend” to other queries in the set, essentially comparing them and potentially incorporating information from relevant ones. Self-attention mechanism may help identify relationships between potential map elements.

In another example, multi-head attention may extend self-attention by having multiple “heads” that focus on different aspects of the relationships between queries. Multi-head attention may allow the ML model to capture diverse information about potential map elements. In yet another example, the transformer decoder may employ a feed forward network. The feed forward network may be a small neural network that further processes the information within each query, potentially adding non-linearity and increasing the capacity of the ML system to learn complex relationships. After processing, the layer may output a new set of M refined queries Qₗ₊₁. These refined queries may represent an improved understanding of the potential map elements. In an aspect, the transformer decoder may decode reference points using, for example, Φ_{ref} neural network. This network may take an individual query (qₗᵢ) from the refined set Qₗ₊₁ as input. Specifically, the Φ_{ref} network may decode the query into a 3D reference point (cₗᵢ) in real-world space. The 3D reference point (cₗᵢ) may be interpreted as a hypothesis for the location of a vertex (corner point) of a potential polyline map element (e.g., a road lane or building edge). By iteratively processing the queries through multiple transformer layers, the ML system may progressively refine these hypotheses, ultimately leading to a set of predicted vertices that define the complete polylines representing the detected map elements.

Feature maps (F) may represent the processed information from the sensor data (camera images and LiDAR point cloud) after going through the BEV encoder. Feature maps may contain rich details about the surrounding environment in a BEV format. In one example, a function denoted by f^{bilinear} may be used to extract a feature vector (fₗᵢ) from the feature maps (F) based on the reference point (cₗᵢ). The aforementioned operation is similar to looking up the relevant information in the feature maps at the location specified by the reference point. The extracted feature vector (fₗᵢ) may then be added to the corresponding query (qₗᵢ) from the previous transformer layer. Such addition may effectively inject information about the surrounding environment (extracted from the feature maps) into the query. This refined query q₍ₗ₊₁₎ᵢ may now have a stronger understanding of the potential map element based on both its previous state and the local features from the sensor data. Φₗ^{reg} neural network may take the refined query (qₗᵢ) as input. This neural network may be a regression network. In other words, Φₗ^{reg} may predict continuous values. The Φₗ^{reg} network may output a prediction \hat{p}ₗᵢ which may represent an offset or adjustment to the reference point (cₗᵢ). This adjustment may help to refine the location of the vertex based on the information in the refined query. The Φₗ^{cls} neural network may also take the refined query (qₗᵢ) as input. The Φₗ^{cls} network may output a classification (ĉₗᵢ) which may determine whether the current vertex is the final point of the polyline/polygon or if there are more vertices to be predicted. In summary, the transformer decoder may iterate through multiple transformer layers. In each layer, the transformer decoder may perform the following steps. Reference points may be proposed for potential vertices (cₗᵢ). Features may be extracted from the feature maps based on these points (fₗᵢ). Queries may be refined by incorporating the extracted features q₍ₗ₊₁₎ᵢ. The ML system may predict adjustments to the reference points (\hat{p}ₗᵢ) and may determine if the vertex is final (cₗᵢ).

The computational cost of a transformer layer may grow quadratically with the input size. In other words, as the number of elements in the input data increases, the processing time required for the transformer layer may grow even faster (proportional to the square of the input size). In local HD map prediction, the input to the transformer decoder may be large. The input may include queries for various map elements (roads, lanes, buildings, etc.) and potentially features extracted from high-resolution sensor data (camera images, LiDAR point clouds, etc.). Due to the quadratic complexity, processing such large inputs may become computationally expensive. The quadratic complexity may limit the ability of the ML system to handle high-resolution data, potentially leading to lower accuracy and limited scalability. The ML system may not be able to fully exploit the rich details present in high-resolution sensor data, leading to less accurate map element detection. The ML system may not be suitable for real-time applications on resource-constrained devices due to the high computational demands. To address this issue, some approaches may resort to using lower-dimensional features as input to the transformer decoder. Low dimensional features may be achieved through techniques like, but not limited to, downsampling and feature compression. Downsampling may reduce the resolution of the sensor data (e.g., reducing the image size or point cloud density). Feature compression may apply dimensionality reduction techniques on the extracted features to decrease their size. While low dimensional features may help manage the computational complexity, such a solution may come at a cost. Lower-dimensional features may lack the necessary information to accurately capture the details of small objects.

Low-dimensional features may lead to reduced performance on small objects and loss of information. The ML system may struggle to detect and localize small map elements like curbs, traffic signs, or narrow lanes. Important details present in the high-resolution data may be discarded during downsampling or compression, hindering the ability of ML system to create a truly accurate and detailed HD map.

When the feature map for the decoder is very large (e.g., containing a high number of elements), it may become challenging for the query embeddings to effectively focus their attention during training. Each query embedding may represent a specific map element (e.g., road, lane, etc.). With a massive feature map, there may be many potential locations and features to attend to. This may make it difficult for the ML system to learn which parts of the feature map are most relevant for each query element. Large feature maps may lead to inaccurate attention weights being assigned during training. The ML system may be unable to identify the most informative features for each map element, hindering its ability to learn effective detection patterns. A large feature map often corresponds to a larger field of view. While larger field of view may seem beneficial for capturing a wider area, it can also limit the effective detection range of the ML system for relevant map elements. Due to the quadratic complexity of transformers, processing a very large feature map may become computationally expensive. This might force the ML system to prioritize processing the central regions of the feature map (corresponding to the area closer to the vehicle) to maintain efficiency. Prioritizing processing of the central regions may lead to a situation where the ML system may struggle to detect map elements located further away from the vehicle, even though they may be present within the field of view represented by the large feature map. These two problems may be interconnected. The difficulty in focusing attention on a large feature map may lead to inaccurate detection of even nearby map elements, further limiting the effective detection range. The disclosed techniques include providing the transformer decoder 220 with better initial information and directing its attention to more relevant areas. Better initial information may help the ML system 216 learn more effective detection patterns for map elements, especially elongated objects like polylines, as described in greater detail below.

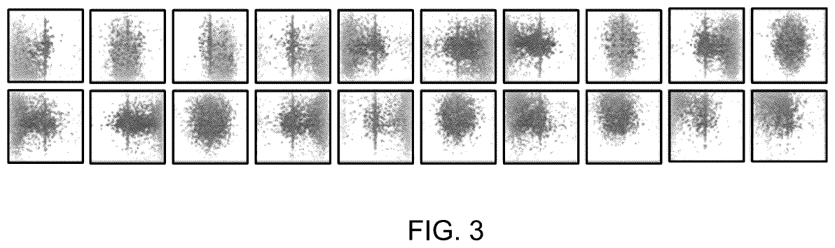

FIG. 3 illustrates difficulties to optimize prediction slots of each object query. The ML system may use a set of learned embeddings to represent different map object queries (e.g., road, lane marking, building).

The learned embeddings are vectors containing numerical values, but they may not inherently convey a specific physical meaning. During training, the ML system may learn to adjust these embeddings to identify relevant features in the input data (BEV feature maps). However, it may be difficult to predict exactly where each query embedding will focus its attention in a new, unseen scene. Because the “meaning” of each embedding may not be explicit, it may become challenging to directly optimize them during training. ML system may not know what features a specific query should focus on. Humans may not easily understand why the ML system makes certain predictions. This can hinder debugging and improving the performance of the ML system. The lack of explicit meaning may make it challenging to directly guide the learning process of the ML system towards focusing on the correct features for each map element.

FIG. 3 shows that each query in the ML system may predict bounding boxes across a very large area in the entire validation set. In other words, a single object query is not necessarily focused on a specific location, making it difficult for the model to learn effective detection patterns. This may become particularly problematic when dealing with elongated objects like polylines representing roads, lanes, or building edges in local HD maps. These objects are inherently not confined to a small, localized region. A single query predicting across a large area may struggle to learn the specific features that distinguish a relevant polyline from other objects or background noise in the feature maps. This can lead to inaccurate or incomplete predictions. Optimizing the performance of the ML system may become challenging because the large prediction area makes it unclear which specific features the query is actually using for its predictions.

Some prior techniques primarily designed for object detection using bounding boxes, which may be well-suited for objects with a defined shape and size. However, polylines are not well-represented by bounding boxes. The large prediction areas illustrated in FIG. 3 suggest that each object query may use global attention. In other words, the object query may consider the entire feature map at once. This may not be efficient for elongated objects that have a specific spatial structure.

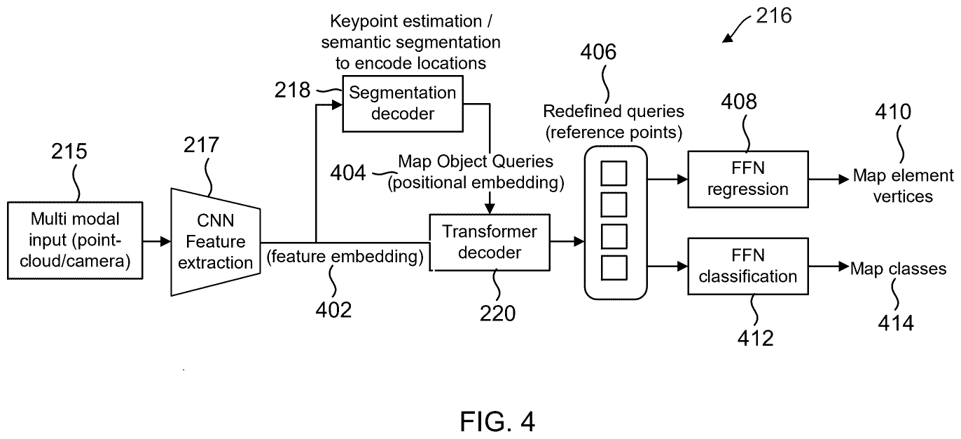

FIG. 4 is a block diagram illustrating architecture of a ML system 216 configured to perform vectorized HD map prediction using semantic maps in accordance with the techniques of this disclosure. The disclosed techniques include providing the transformer decoder 220 with better initial information and directing its attention to more relevant areas. Better initial information may help the ML system 216 learn more effective detection patterns for map elements, especially elongated objects like polylines. The disclosed techniques may use anchor regions determined by a separate segmentation head in the ML system 216. These regions may represent potential locations for specific map elements (e.g., roads, lanes, buildings). Based on the anchor regions, ML system 216 may create initial query embeddings that are more informative than randomly initialized ones. These embeddings may encode information about the expected location and shape of the target map element based on the corresponding anchor region.

The disclosed techniques provide a mechanism to direct the attention learning region of transformer decoder 220 to a smaller range around the anchor region. This may prevent the ML system 216 from attending to irrelevant parts of the feature map and may help ML system 216 focus on more relevant features for the specific map element within the anchor region. By focusing on a smaller region, the ML system 216 may learn more efficiently and avoid wasting resources on less relevant areas of the feature map. The initial query embedding based on the anchor region may provide a good starting point for the transformer decoder 220, potentially leading to more accurate predictions for the target map element. Confining the attention to a local region around the anchor region may be particularly beneficial for elongated objects like polylines. Confining the attention may allow the ML system 216 to focus on the specific spatial structure of the object within the expected location. Unlike the large prediction areas and global attention illustrated in FIG. 3, the disclosed techniques may provide more focused guidance for the transformer decoder 220, making it better suited for the task of local HD map prediction.

There are two main ways to represent HD maps for vehicles: rasterized and vectorized. Rasterized representation may include a grid laid over the map. Each cell in the grid may hold a value indicating whether a specific road element (like a lane marker) exists within that cell. This approach is similar to how images are represented digitally, with each pixel holding color information. The rasterized approach is simple to implement and computationally efficient for storing and retrieving basic information. However, this approach may be bulky for storing detailed maps, especially with high resolution. The rasterized approach also is not ideal for tasks requiring precise understanding of object shapes and boundaries.

The vectorized representation techniques may focus on representing road elements using geometric shapes like polylines (connected lines) and polygons (closed areas). The vectorized representation may use lines for lane boundaries and a polygon for a pedestrian crossing. The vectorized representation may provide more compact storage compared to raster for detailed maps. This representation may enable more precise representation of object shapes and boundaries, important for ADAS tasks like path planning. Within vectorized representation, there may be different ways to define the partitions and how elements are stored. The HD map may be divided into smaller grids (sub-cells). For each sub-cell it may be defined if a specific road element passes through it. This technique may be efficient for sparse environments but may not capture precise boundaries. The entire HD map may be considered a single unit and may be divided into logical partitions. Each partition may hold information about the road elements within it, typically represented as key points (vertices). The shape of an element may be defined by an array of points (vertices) that it connects through. For example, a lane boundary may be an array of points representing the line. The key aspect here may be the concept of “lying on top.” When two consecutive vertices in the array are connected with a straight line, this line may ideally overlay the actual road element without deviating significantly. In the case of a lane boundary, drawing a line between two vertices may match the center line of the lane marking on the road. Small deviations may be unavoidable due to sensor limitations or map generation processes. However, the overall goal is for the line segments to accurately represent the real-world element. The disclosed technique may allow for efficient storage of complex shapes. By storing just the key points (vertices), the HD map may represent more intricate features like curved lane boundaries without requiring excessive data. As long as the vertices are defined accurately, the resulting polylines and polygons may closely resemble the actual road elements, providing a clear picture of the road layout.

Referring back to FIG. 4, the ML system 216 may analyze sensor data 215 (like camera, LiDAR) to identify potential key points (vertices) that may be part of road elements. Once the ML system 216 identifies potential points, the ML system 216 may perform a separate step to associate them into meaningful shapes. For example, connecting points to form a polyline for a lane boundary. The transformer architecture in the disclosed system may aim to streamline this process. The system may take the raw sensor data 215 (LiDAR or camera) as input and may use its encoder-decoder structure to perform both tasks simultaneously. The encoder part of the transformer architecture (CNN 217) may analyze the sensor data 215, extracting relevant features that describe the scene, including potential locations of key points.

The CNN 217 in the ML system 216 may process the multi-modal input sensor data 215. The output of the CNN 217 may be a feature map with three dimensions (H×M×K) . The first dimension (H) may correspond to the height of the processed input data (e.g., the height of a resized image or the height of the feature space after processing the point cloud). The second dimension (M) may correspond to the width of the processed input data (similar to height). The third dimension (K) may represent the number of feature channels extracted by the CNN 217. Each channel may capture specific aspects of the input sensor data 215, such as, but not limited to, edges, textures, or object parts. The generated feature map may contain high-level information about the scene, but the feature map may not necessarily directly represent the locations or classes of map elements. The feature map may serve as an intermediate representation for further processing.

The transformer decoder 220 may leverage the features extracted by the CNN 217 and may use its attention mechanism to directly predict the final key points for each road element. The attention mechanism may allow the transformer decoder 220 to “focus” on relevant parts of the feature map, making connections between potential key points and forming coherent shapes. Advantageously, by combining both tasks within the transformer architecture illustrated in FIG. 4, the ML system 216 may potentially reduce computational complexity compared to running separate algorithms. The joint learning process may lead to better accuracy as the model of the ML system 216 may learn to identify and associate key points in a more cohesive way.

In other words, based on the processed features and potentially object-specific queries (as discussed previously), the transformer decoder 220 may generate initial reference points. These points may be starting positions for polylines or corner points for polygons. Finally, the transformer decoder 220 may leverage the reference points to predict the actual road elements as polylines (lane boundaries) or polygons (pedestrian crossings, traffic signs, etc.).

The purpose of a segmentation decoder is to predict, for each pixel in an image, the class label (e.g., road, lane, building) of the element the pixel represents. In the disclosed techniques, the segmentation decoder 218 may be specifically designed for local HD map prediction. The segmentation decoder 218 may take the sensor data 215 (e.g., camera images, LiDAR point cloud) as input and may output probability maps. Each pixel in a probability map may correspond to a specific location in the scene. The value at each pixel may represent the probability that a particular map element (e.g., road, lane marking) exists at that location. The ML system 216 may generate multiple probability maps, one for each type of map element the ML system 216 needs to detect (e.g., road probability, lane marking probability, and the like). In an aspect, the ML system 216 may use a thresholding technique on these probability maps. In other words, the ML system 216 may set a probability value (th) as a cutoff point.

Pixels with a probability higher than the threshold (th) may be considered highly likely to belong to the corresponding map element. These pixels may then be included in the mask region. Pixels with a probability lower than the threshold may be considered less likely to belong to the map element and may be excluded from the mask region. The mask regions derived from the probability maps may provide valuable information for the transformer decoder 220. The mask regions may act as a filter, guiding the transformer decoder 220 to focus its attention on areas with a higher likelihood of containing the target map element. This may reduce the attention learning region, as described earlier, making the ML system 216 more efficient and potentially leading to more accurate predictions. In one non-limiting example, the segmentation decoder 218 may predict a high probability for “road” in a specific region of the camera image. This region would be included in the mask for the “road” query in the transformer decoder 220. The transformer decoder 220 would then focus its attention on this masked region, analyzing the features within it to refine its prediction for the road location and boundaries.

As shown in FIG. 4, CNN 217 may take sensor data 215 as input. One type of input sensor data 215 may include point cloud data from LiDAR sensors 128. This data may represent the 3D structure of the environment with points and their corresponding intensities. Another type of input sensor data 215 may include camera images capturing the visual details of the scene. The CNN 217 may process both the point cloud and camera image data separately. The CNN 217 may extract informative features from each data source. These features may capture essential information about the shapes, colors, and textures present in the scene. The extracted features from the CNN 217 for both the point cloud and camera image may then be embedded into a common feature space. Feature embedding 402 may allow ML system 216 to combine information from these different modalities for a more comprehensive understanding of the environment. The segmentation decoder 218 branch may use a separate CNN architecture. The segmentation decoder 218 may take the embedded features as input and may perform two potential tasks: keypoint estimation and semantic segmentation.

Segmentation decoder 218 may predict the keypoints (critical points) of objects or lane markings within the scene. These keypoints may provide valuable information about the location and structure of map elements.

Alternatively, segmentation decoder 218 may perform semantic segmentation, predicting a probability map for each pixel in the scene. The probability map may indicate the likelihood of each pixel belonging to a specific map element class (e.g., road, lane, building). The output of the segmentation decoder 218 (map object queries 404) may be embedded into a feature space that is compatible with the transformer decoder 220. Map object queries 404 may represent the different map elements the ML system 216 is trained to detect/predict (e.g., road, lane marking, building).

The segmentation decoder 218 may take the feature map extracted by the CNN 217 as input. The output of the segmentation decoder 218 may be a set of predicted probability maps, with three dimensions (H×M×C). The first dimension (H), same as with the CNN feature map, may represent the height of the output probability maps. The second dimension (M), same as with the CNN feature map, may represent the width of the output probability maps. The third dimension (C) may represent the number of map element classes the ML system 216 is trained to predict. In a non-limiting example, C=3, indicating the ML system 216 may predict probabilities for three classes: lane markings, road boundaries, and pedestrian crossings. Each pixel in a probability map may correspond to a specific location in the scene. The value at each pixel may represent the probability that a particular map element class (e.g., lane marking with C=1) exists at that location. The segmentation decoder 218 may help identify potential locations for different map elements by analyzing the features extracted by the CNN 217.

Unlike traditional object detection approaches that may use pre-defined anchors or grids, the disclosed techniques may assign a unique object query 404 for each class of object the ML system 216 is trained to predict (e.g., lane boundaries, pedestrian crossings). These object queries 404 are essentially starting points or prompts for the transformer decoder 220. The transformer decoder 220 may utilize a mechanism called attention. Attention may allow the transformer decoder 220 to focus on specific parts of the fused feature map that are more relevant to each object query 404. The transformer decoder 220 may have multiple attention layers, stacked one after another. As the transformer decoder 220 processes information through these layers, the object query 404 may be progressively refined based on the more relevant parts of the feature map it processes. After passing through these multi-layer attention modules, the object query 404 may become highly specific to the target object class. These refined queries 406 may then be used to predict the final outcome, which in this case, could be the center point of the object (e.g., center of the lane for lane boundaries). In traditional object detection, predicting the center point may be sufficient for tasks like identifying and classifying objects (e.g., car, pedestrian) within an image. The center of an object may provide a general location. However, the disclosed system deals with vectorized map prediction, specifically focusing on elongated objects like lanes and pedestrian crossings. Predicting just the center point would not be enough to represent these objects accurately. Such objects may require polylines (connected lines) or polygons (areas enclosed by lines) to define their complete boundaries. While the initial object query 404 may be a starting point, the multi-layer attention mechanism in the transformer decoder 220 may play an important role here. In the case of lanes, the transformer decoder 220 may focus on areas with high probability of containing lane markings. This refinement process may steer the object query 404 away from simply predicting the center and may guide it towards understanding the entire lane boundary.

After the multi-layer attention, the final prediction may not solely be the center point. The refined query 406 may now encode information about the entire lane boundary. The information about the lane boundary may be used to generate a series of points along the lane marking. This could involve predicting multiple points along the perceived lane, essentially creating a polyline that represents the complete lane boundary. Depending on the object class (e.g., pedestrian crossing), the final prediction may involve generating corner points that define the entire area of the object.

Map object queries 404 may act as initial proposals for potential object locations within the feature map. These object queries 404 may not be random placements across the entire map. These object queries 404 could be strategically chosen based on, for example, high-probability regions and class specific initialization. As discussed earlier, the ML system 216 may pre-process the feature map to identify areas with a high likelihood of containing specific objects (e.g., lane boundaries). The object queries 404 may then be placed within these high-probability regions. The object queries 404 may be specific to each object class (lane boundaries, pedestrian crossings). This may help guide the transformer decoder 220 towards focusing on relevant parts of the feature map. Each object query 404 may have a specific location within the feature map, indicating the initial proposed position for the object. Feature embeddings 402 may be extracted from the feature map using the CNN 217 and may capture relevant information about the surrounding area of the query location. This information may help the transformer decoder 220 understand the context of the proposed object. The transformer decoder 220 may take both the object query 404 location and its associated feature embedding 402 as input. The transformer decoder 220 may then perform a series of refinement steps through multiple layers. Each layer may leverage attention to focus on relevant parts of the feature map relative to the current state of the object query 404. As the transformer decoder 220 progresses through layers, the attention may focus on increasingly specific regions based on the information gathered so far. Within each layer, there may be a neural network function that further refines the object query 404 based on the attended information from the feature map. This refinement may help the query become more specific to the target object. The initial object queries 404 may be considered coarse proposals. As object queries 404 progress through the layers of the transformer decoder 220, the attention mechanism and neural network functions may refine them into more precise representations, leading to the final “refined queries” 406. After multiple refinement steps, the object queries 404 may become highly specific to the target object class. These refined queries 406 may then be used to generate reference points. Reference points may be initial positions for polylines (lane boundaries) or corner points for polygons (pedestrian crossings). Based on these reference points, the ML system 216 may perform the final detection tasks, such as, but not limited to, regression and classification. The regression step may refine the reference points to obtain more accurate final locations for the vertices of the object (e.g., precise lane boundary coordinates).

The ML system 216 may classify the object type, determining whether the object is a lane boundary, pedestrian crossing, or another element based on the processed information. Positional embeddings may be added to the object queries 404. Positional embeddings may encode spatial information, providing the ML system 216 with some initial understanding of where each map element might be located in the scene. Based on the refined queries 406, the transformer decoder 220 may predict the final locations and characteristics of the detected map elements.

As described earlier, the process may start with defining object queries 404. Placement of the object queries 404 could be, for example, strategically chosen (described above) or class-specific. Class-specific placement may be tailored to specific object types (lane boundaries, pedestrian crossings). Each object query 404 may be associated with at least two important pieces of information. Location is a position of the object query 404 within the feature map, indicating the initial proposed spot for the object. Feature embeddings 402 may be extracted from the feature map using the CNN 217. These embeddings 402 may capture relevant information about the surrounding area of the query location. The object queries 404 may then be fed into the transformer decoder 220. Within each layer, there may be a neural network function that may further refine the object query 404 based on the attended information from the feature map. Such function may help the object query 404 become more specific to the target object. The initial object queries 404 may be progressively refined through the transformer decoder 220. This refinement process may lead to the final detection. After multiple refinement steps, the object queries 404 may become highly specific to the target object class.

As described earlier, the transformer decoder 220 may refine the object queries 404, through a series of attention and feed-forward operations, allowing the queries to capture the relevant information about the target map elements. The output of the transformer decoder 220 may comprise one or more refined queries 406. The refined queries 406 may be interpreted as representing hypotheses about the locations of keypoints or vertices (corner points) for the targeted map elements. As shown in FIG. 4, each refined query 406 may be fed into one or more Feed Forward Networks (FFN) specifically designed for regression, classification, etc.

A first FFN network 408 may predict an offset or adjustment based on the information encoded in the refined query 406. As a non-limiting example, a refined query may represent a potential lane marking location. The first FFN network 408 may predict a slight adjustment to this location based on the features the refined query 406 attended to in the transformer decoder 220. By combining the original location proposed by the refined query 406 and the predicted adjustment from the first FFN network 408, the ML system 216 may obtain a more precise prediction for the location of a map element vertex 410. Each refined query 406 may also be fed into a separate second FFN 412 designed for classification. The second FFN network 412 may predict the class label 414 for the map element that the refined query 406 corresponds to. For example, a refined query may predict a lane marking with the FFN classification, while another refined query may predict a road boundary. The final output of this stage may be a set of predicted map element vertices 410 along with their corresponding class labels 414. This information may be used to reconstruct the complete polylines (e.g., lane markings, road boundaries) or other geometric shapes representing the detected map elements.

The CNN feature map may provide the foundation for the segmentation decoder 218. The segmentation decoder 218 may utilize the features within the map to predict the probability of various map elements existing at different locations.

In standard transformer-based models, map object queries are often randomly initialized or use basic heuristics for placement. Such queries may lack a clear physical meaning in terms of location. It may be difficult to predict where each query will focus its attention in the feature maps. The ML system 216 may waste resources attending to irrelevant areas or struggling to learn effective detection patterns due to the lack of initial guidance. The disclosed techniques address these issues by leveraging the output of the segmentation decoder 218. Advantageously, the ML system 216 may select anchor points from high-probability regions in the segmentation probability maps. In other words, the segmentation decoder 218 may predict the likelihood of different map elements (lanes, roads) at various locations. By focusing on high-probability regions, the ML system 216 may identify areas with a high chance of containing a specific map element. The coordinates of these high-probability points may then be used as anchor points. The high-probability points may be converted into initial map object queries 404 for the transformer decoder 220.

Each anchor point, and consequently each map object query 404 derived from it, may have a clear physical meaning. Each anchor point may represent a probable location in the scene with a high likelihood of containing a particular map element. Because the object queries 404 may be derived from informative locations, the ML system 216 may be more efficiently optimized to focus on the relevant features around the anchor points. Improved optimization may reduce the need for the ML system 216 to “search” for the correct locations entirely. Since the anchor points may be selected from relevant regions, the corresponding object queries 404 may be inherently focused on predicting polylines or polygons (like lane markings or road boundaries) near those locations. Such focus may reduce the need for the ML system 216 to predict these elements far away from the anchor point, making the task more manageable.

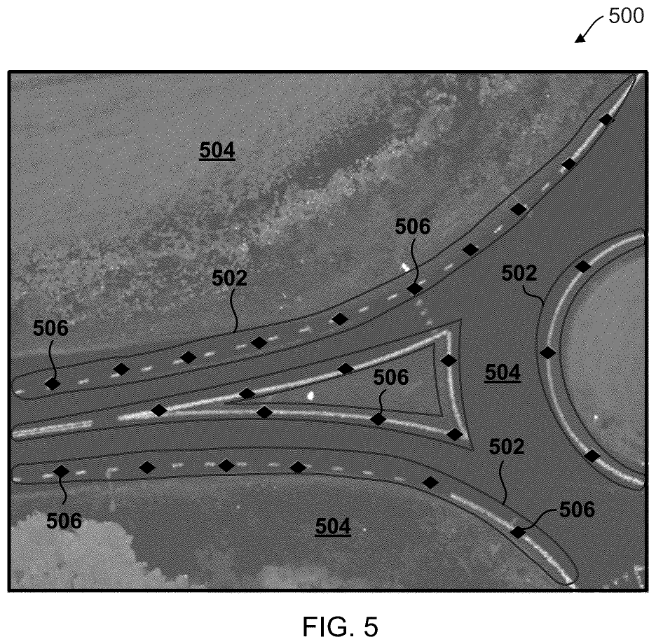

FIG. 5 illustrates a probability map 500 in accordance with the techniques of this disclosure. FIG. 5 depicts the output of the segmentation decoder 218 focusing on the “lane marking” class. Regions 502 may represent areas with a high probability of containing lane markings. These regions may be the most likely locations for the ML system 216 to find lane boundaries. Regions 504 may represent areas with a lower probability of containing lane markings. The probability map 500 may play an important role in ability of ML system 216 to predict lane markings for the local HD map. The coordinates of regions 502 may then be used as anchor points for generating initial map object queries 404 that may be fed into the transformer decoder 220.

The transformer decoder 220 may leverage the information from the probability map 500 to focus its attention on areas with a higher likelihood of containing lane markings. The focused attention may improve efficiency and may reduce the need to attend to irrelevant parts of the scene.

Unlike traditional approaches that randomly select points from the entire feature map as initial queries for the decoder, the disclosed techniques contemplate focus on specific regions. ML system 216 may achieve this by first masking the feature map, selecting only the areas with the highest probability (e.g., higher than a threshold probability) of containing the objects the ML system 216 may be interested in (e.g., lane boundaries). In an aspect, the areas with highest probabilities could be selected using probability maps, such as probability map 500 generated by the segmentation decoder 218. The disclosed techniques may guide the transformer decoder 220 towards focusing on relevant parts of the masked feature map. The initialized object queries 404 may then be fed into the transformer decoder 220. The transformer decoder 220 may utilize the masked feature map and the object queries 404 to generate reference points for the desired objects. These reference points may be initial positions for polylines or corner points for polygons, depending on the object class. Finally, based on these reference points, the transformer decoder 220 may generate the final predictions for the polylines or polygons that represent the objects on the map. By focusing on high-probability regions (such as regions 502 in FIG. 5), the computational load placed on the transformer decoder 220 may be reduced as the transformer decoder may not need to process irrelevant areas of the feature map (such as regions 504 in FIG. 5). Initializing queries specific to object classes may guide the decoder towards more accurate predictions for each object type.

By masking out low-probability regions 504, the ML system 216 may mitigate the influence of noise or irrelevant information in the final predictions. The diamonds 506 shown in FIG. 5 represent the initial positions of these object queries 404 for each class. The diamonds 506 may be strategically placed within the high-probability regions 502, providing starting points for the transformer decoder 220 to refine and generate the final object boundaries (polylines/polygons). It should be noted that while feature extraction and fusion are important steps, the advantage of the disclosed techniques lies in using the transformer decoder 220 for prediction. Traditional approaches may rely on different architectures for prediction, but transformers excel at capturing long-range dependencies in the data, making them particularly suitable for tasks like predicting elongated objects like lanes and road boundaries.

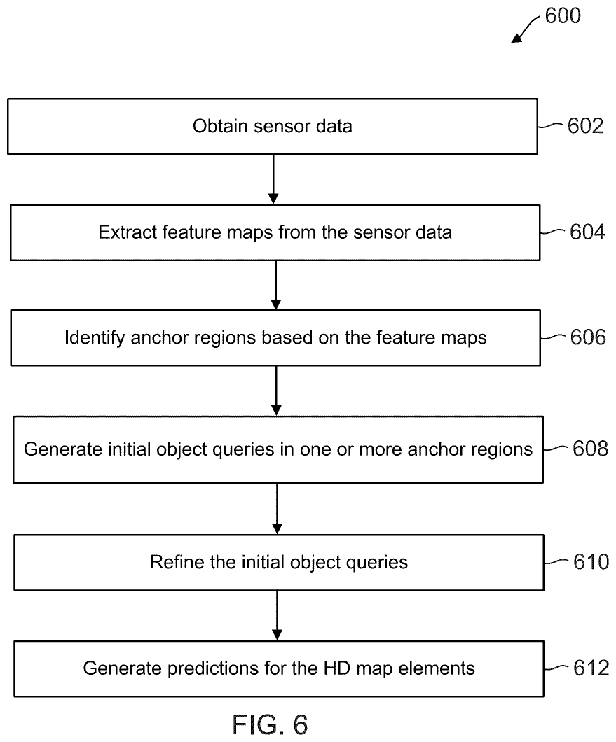

FIG. 6 is a flowchart illustrating an example method for generating predictions for vectorized HD map elements in accordance with the techniques of this disclosure. Although described with respect to computing system 200 (FIG. 2), it should be understood that other computing devices may be configured to perform a method similar to that of FIG. 6.

At block 602, ML system 216 may obtain sensor data generated by one or more sensors of a vehicle.

At block 604, ML system 216 may extract one or more feature maps from the sensor data. The generated feature map may contain high-level information about the scene.

At block 606, ML system 216 may identify one or more anchor regions based on the one or more feature maps. The one or more anchor regions represent potential locations for one or more vectorized HD map elements. The vectorized HD map represents an environment surrounding the vehicle. The one or more anchor regions represent potential locations for one or more vectorized HD map elements.

At block 608, ML system 216 may generate one or more initial object queries in the one or more anchor regions. The one or more object queries are associated with a specific vectorized HD map element. The initial object queries 404 may be considered coarse proposals.

At block 610, ML system 216 may refine, by employing a transformer decoder, the one or more initial object queries based on the one or more feature maps and to generate one or more refined object queries. After multiple refinement steps, the object queries 404 may become highly specific to the target object class. These refined queries 406 may then be used to generate reference points.

At block 612, ML system 216 may generate one or more predictions for the one or more vectorized HD map elements based on the one or more refined queries, including their class labels (e.g., road, lane marking) and their corresponding geometric descriptions (e.g., bounding boxes, polylines).

Thus, the techniques of this disclosure use class agnostic functions based only on unsupervised/non-annotated perception data, to determine ROIs for human annotations and use the combination of a model's pre-annotations and class agnostic functions to select ROIs along with pre-annotations for human refinement. The adaptive annotation framework described herein provides for a large improvement in the overall annotation quality by incorporating a semi-automatic supervision for manual annotation.

The following numbered clauses illustrate one or more aspects of the devices and techniques described in this disclosure.
Clause 1. A method for generating predictions for vectorized High Definition (HD) map elements includes obtaining sensor data generated by one or more sensors of a vehicle; extracting one or more feature maps from the sensor data; identifying one or more anchor regions based on the one or more feature maps, wherein the one or more anchor regions represent potential locations for one or more vectorized HD map elements, and wherein the vectorized HD map represents an environment surrounding the vehicle; generating one or more initial object queries in the one or more anchor regions, wherein the one or more initial object queries are associated with a specific vectorized HD map element; refining, by a transformer decoder, the one or more initial object queries based on the one or more feature maps to generate one or more refined object queries; and generating one or more predictions for the one or more vectorized HD map elements based on the one or more refined object queries.
Clause 2. The method of clause 1, wherein identifying the one or more anchor regions further comprises: generating one or more probability maps, wherein the one or more probability maps are associated with the specific vectorized HD map element.
Clause 3. The method of clause 2, wherein the one or more probability maps indicate a likelihood of each pixel belonging to a specific HD map element class.
Clause 4. The method of clauses 1-3, wherein the transformer decoder comprises a plurality of attention layers and wherein the one or more refined object queries are generated using a series of attention and feed-forward operations within the plurality of attention layers.
Clause 5. The method of clauses 1-4, further comprising: identifying one or more anchor points within the one or more anchor regions, wherein the one or more anchor points identify probable locations for the one or more vectorized HD map elements.
Clause 6. The method of clauses 1-5, wherein the one or more predictions comprise one or more class labels of the one or more vectorized HD map elements or geometric descriptions of the one or more vectorized HD map elements.
Clause 7. The method of clauses 1-6, wherein the transformer decoder processes the one or more anchor regions when generating the one or more predictions for the one or more vectorized HD map elements.
Clause 8. The method of clauses 1-7, wherein the one or more feature maps encode information associated with an expected location and shape of the vectorized HD map elements.
Clause 9. The method of clauses 1-8, further comprising operating an Advanced Driver Assistance Systems (ADAS) system based on the one or more predictions.
Clause 10. An apparatus for generating predictions for vectorized High Definition (HD) map elements, the apparatus comprising: a memory for storing sensor data; and processing circuitry in communication with the memory, wherein the processing circuitry is configured to: obtain the sensor data generated by one or more sensors of a vehicle; extract one or more feature maps from the sensor data; identify one or more anchor regions based on the one or more feature maps, wherein the one or more anchor regions represent potential locations for one or more vectorized HD map elements, and wherein the vectorized HD map represents an environment surrounding the vehicle; generate one or more initial object queries in the one or more anchor regions, wherein the one or more initial object queries are associated with a specific vectorized HD map element; refine, by a transformer decoder, the one or more initial object queries based on the one or more feature maps to generate one or more refined object queries; and generate one or more predictions for the one or more vectorized HD map elements based on the one or more refined object queries.
Clause 11. The apparatus of clause 10, wherein the processing circuitry configured to identify the one or more anchor regions is further configured to: generate one or more probability maps, wherein the one or more probability maps are associated with the specific vectorized HD map element.
Clause 12. The apparatus of clause 11, wherein the one or more probability maps indicate a likelihood of each pixel belonging to a specific HD map element class.
Clause 13. The apparatus of clauses 10-12, wherein the transformer decoder comprises a plurality of attention layers and wherein the one or more refined object queries are generated using a series of attention and feed-forward operations within the plurality of attention layers.
Clause 14. The apparatus of clauses 10-13, wherein the processing circuitry is further configured to: identify one or more anchor points within the one or more anchor regions, wherein the one or more anchor points identify probable locations for the one or more vectorized HD map elements.
Clause 15. The apparatus of clauses 10-14, wherein the one or more predictions comprise one or more class labels of the one or more vectorized HD map elements or geometric descriptions of the one or more vectorized HD map elements.
Clause 16. The apparatus of clauses 10-15, wherein the transformer decoder processes the one or more anchor regions when generating the one or more predictions for the one or more vectorized HD map elements.
Clause 17. The apparatus of clauses 10-16, wherein the one or more feature maps encode information associated with an expected location and shape of the vectorized HD map elements.
Clause 18. The apparatus of clauses 10-17, wherein the processing circuitry is further configured to: operate an Advanced Driver Assistance Systems (ADAS) system based on the one or more predictions.
Clause 19. Non-transitory computer-readable storage media having instructions encoded thereon, the instructions configured to cause processing circuitry to: obtain sensor data generated by one or more sensors of a vehicle; extract one or more feature maps from the sensor data; identify one or more anchor regions based on the one or more feature maps, wherein the one or more anchor regions represent potential locations for one or more vectorized HD map elements, and wherein the vectorized HD map represents an environment surrounding the vehicle; generate one or more initial object queries in the one or more anchor regions, wherein the one or more initial object queries are associated with a specific vectorized HD map element; refine, by a transformer decoder, the one or more initial object queries based on the one or more feature maps to generate one or more refined object queries; and generate one or more predictions for the one or more vectorized HD map elements based on the one or more refined object queries.
Clause 20. The non-transitory computer-readable storage media of clause 19, wherein the processing circuitry configured to identify the one or more anchor regions is further configured to: generate one or more probability maps, wherein the one or more probability maps are associated with the specific vectorized HD map element.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of random-access memory (RAM), read-only memory (ROM), electrically erasable ROM (EEPROM), compact disc ROM (CD-ROM) or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for generating predictions for vectorized High Definition (HD) map elements, the method comprising:
obtaining sensor data generated by one or more sensors of a vehicle;
extracting one or more feature maps from the sensor data;
identifying one or more anchor regions based on the one or more feature maps, wherein the one or more anchor regions represent potential locations for one or more vectorized HD map elements, and wherein the vectorized HD map represents an environment surrounding the vehicle;
generating one or more initial object queries in the one or more anchor regions, wherein the one or more initial object queries are associated with a specific vectorized HD map element;
refining, by a transformer decoder, the one or more initial object queries based on the one or more feature maps to generate one or more refined object queries; and
generating one or more predictions for the one or more vectorized HD map elements based on the one or more refined object queries.

2. The method of claim 1, wherein identifying the one or more anchor regions further comprises:
generating one or more probability maps, wherein the one or more probability maps are associated with the specific vectorized HD map element.

3. The method of claim 2, wherein the one or more probability maps indicate a likelihood of each pixel belonging to a specific HD map element class.

4. The method of claim 1, wherein the transformer decoder comprises a plurality of attention layers and wherein the one or more refined object queries are generated using a series of attention and feed-forward operations within the plurality of attention layers.

5. The method of claim 1, further comprising:
identifying one or more anchor points within the one or more anchor regions, wherein the one or more anchor points identify probable locations for the one or more vectorized HD map elements.

6. The method of claim 1, wherein the one or more predictions comprise one or more class labels of the one or more vectorized HD map elements or geometric descriptions of the one or more vectorized HD map elements.

7. The method of claim 1, wherein the transformer decoder processes the one or more anchor regions when generating the one or more predictions for the one or more vectorized HD map elements.

8. The method of claim 1, wherein the one or more feature maps encode information associated with an expected location and shape of the vectorized HD map elements.

9. The method of claim 1, further comprising operating an Advanced Driver Assistance Systems (ADAS) system based on the one or more predictions.

10. An apparatus for generating predictions for vectorized High Definition (HD) map elements, the apparatus comprising:
a memory for storing sensor data; and
processing circuitry in communication with the memory, wherein the processing circuitry is configured to:
obtain the sensor data generated by one or more sensors of a vehicle;
extract one or more feature maps from the sensor data;
identify one or more anchor regions based on the one or more feature maps, wherein the one or more anchor regions represent potential locations for one or more vectorized HD map elements, and wherein the vectorized HD map represents an environment surrounding the vehicle;
generate one or more initial object queries in the one or more anchor regions, wherein the one or more initial object queries are associated with a specific vectorized HD map element;
refine, by a transformer decoder, the one or more initial object queries based on the one or more feature maps to generate one or more refined object queries; and
generate one or more predictions for the one or more vectorized HD map elements based on the one or more refined object queries.

11. The apparatus of claim 10, wherein the processing circuitry configured to identify the one or more anchor regions is further configured to:
generate one or more probability maps, wherein the one or more probability maps are associated with the specific vectorized HD map element.

12. The apparatus of claim 11, wherein the one or more probability maps indicate a likelihood of each pixel belonging to a specific HD map element class.

13. The apparatus of claim 10, wherein the transformer decoder comprises a plurality of attention layers and wherein the one or more refined object queries are generated using a series of attention and feed-forward operations within the plurality of attention layers.

14. The apparatus of claim 10, wherein the processing circuitry is further configured to:
identify one or more anchor points within the one or more anchor regions, wherein the one or more anchor points identify probable locations for the one or more vectorized HD map elements.

15. The apparatus of claim 10, wherein the one or more predictions comprise one or more class labels of the one or more vectorized HD map elements or geometric descriptions of the one or more vectorized HD map elements.

16. The apparatus of claim 10, wherein the transformer decoder processes the one or more anchor regions when generating the one or more predictions for the one or more vectorized HD map elements.

17. The apparatus of claim 10, wherein the one or more feature maps encode information associated with an expected location and shape of the vectorized HD map elements.

18. The apparatus of claim 10, wherein the processing circuitry is further configured to:
operate an Advanced Driver Assistance Systems (ADAS) system based on the one or more predictions.

19. Non-transitory computer-readable storage media having instructions encoded thereon, the instructions configured to cause processing circuitry to:
obtain sensor data generated by one or more sensors of a vehicle;
extract one or more feature maps from the sensor data;
identify one or more anchor regions based on the one or more feature maps, wherein the one or more anchor regions represent potential locations for one or more vectorized HD map elements, and wherein the vectorized HD map represents an environment surrounding the vehicle;
generate one or more initial object queries in the one or more anchor regions, wherein the one or more initial object queries are associated with a specific vectorized HD map element;
refine, by a transformer decoder, the one or more initial object queries based on the one or more feature maps to generate one or more refined object queries; and
generate one or more predictions for the one or more vectorized HD map elements based on the one or more refined object queries.

20. The non-transitory computer-readable storage media of claim 19, wherein the processing circuitry configured to identify the one or more anchor regions is further configured to:
generate one or more probability maps, wherein the one or more probability maps are associated with the specific vectorized HD map element.
